(19) United States
(12) Patent Application Publication
(10) Pub. No.: US 2023/0175530 A1
(43) Pub. Date: Jun. 8, 2023

(54) HYDRAULIC BOOSTER USING VARIABLE-VOLUME PISTON

(71) Applicant: Seoung Il Park, Yongin-si (KR)

(72) Inventor: Seoung Il Park, Yongin-si (KR)

(21) Appl. No.: 17/924,085

(22) PCT Filed: May 7, 2021
(86) PCT No.: PCT/KR2021/005740

§ 371 Date: Nov. 8, 2022

(30) Foreign Application Priority Data
May 8, 2020 (KR) 10-2020-0055381

(51) Int. Cl. F15B 11/032; F15B 15/14

(52) U.S. Cl. CPC F15B 11/0325; F15B 15/1447

(57) ABSTRACT

A hydraulic booster using a variable-volume piston includes a main cylinder configured such that, if a fluid introduced into the upper portion of a main piston is pressurized by a pressurizing means, the fluid in the lower portion of the main piston is output. A guide moves downwards separately from the main piston and then moves to the original position by a return means. A variable-volume piston is integrally assembled on the guide such that the volume thereof increases during a downward movement and decreases during an upward movement, thereby changing the volume of the upper side of the main piston. A fluid storage-and-supply unit connects to fluid channels in the upper and lower portions of the main cylinder. This configuration boosts the pressure of the fluid discharged through the lower portion of the main cylinder due to a volume change caused by upward/downward movements of the variable-volume piston.

### TECHNICAL FIELD

The present invention relates to a hydraulic booster using a variable-volume piston and, more particularly, to a hydraulic booster using a variable-volume piston, in which a physical change by the use of a variable-volume piston is applied to the volume of the upper portion of a main piston and the stroke length of the main piston is increased without reducing the volume of the main piston so that the main piston can move more when moving, thereby boosting the pressure of fluid output through the lower portion of a main cylinder.

### BACKGROUND ART

In general, the transfer of a force by the pressure of fluid is based on Pascal's principle, which has the meaning that “if the fluid contained in a sealed container is incompressible, the pressure applied to the fluid is transferred to all parts of the fluid with the same magnitude”, and all hydraulic devices currently in use employ this principle.

In other words, it can be said that the internal pressure generated by applying a force to the sealed container is the same.

As a prior art based on such Pascal's principle, Korean Patent No. 10-2027231 (Published, 2 Oct. 2019), disclosed in Patent Document 1, suggests “a device for varying the volume of a gas chamber of a hydraulic breaker”.

Patent document 1 improves the crushing efficiency of the bedrock, wherein a chamber plunger is lowered in a chamber so as to switch long strokes to short strokes and reduces the volume of a gas chamber, compared to the volume of the gas chamber during the long strokes, so that the volume of the gas chamber is compressed with gas pressure relatively greater than the volume of the gas chamber during the long strokes, resulting in the increase of the gas pressure of the gas chamber and the striking force of a piston, thereby preventing the phenomenon in which the striking force is lowered even in the short strokes.

### PRIOR ART DOCUMENT

(Patent Document 1) Korean Patent No. 10-2027231 (Published, 2 Oct. 2019) “Device for varying the volume of a gas chamber of a hydraulic breaker”

### DETAILED DESCRIPTION OF THE INVENTION

### Technical Problem

However, patent document 1 has a limit in reducing the volume, since the volume of the gas chamber is reduced only by the “distance”’ where the chamber plunger in the chamber is lowered for the conversion to the short stroke or by the piston of a lifting cylinder, which is lowered. Therefore, patent document 1 has a problem in that it is difficult to increase the gas pressure inside the gas chamber so that the piston operation distance in a head cap cannot be increased.

Accordingly, an object of the present invention is to provide a hydraulic booster using a variable-volume piston, in which when a pressurization means at the upper portion of a main piston is lowered to pressurize fluid that has been introduced in a certain amount into the upper portion of the main piston of the main cylinder, the volume of the upper portion of the main piston is further reduced due to not only the volume decrease by the lowering of the pressurization means but also the volume change by a variable-volume piston, so that the main piston moves a greater distance when it is moved, even without reducing the volume thereof, thereby boosting the pressure of the fluid discharged through the lower portion of the main cylinder.

### Problem Solving Means

In order to achieve the above object, the present invention includes: a main cylinder provided with a ring type main piston such that, if fluid introduced into an upper portion is pressurized by a pressurizing means, fluid in the lower portion of the main piston is output; a guide for guiding the movement of the main piston, the guide moving downwards separately from the main piston and then returning to an original position by a return means; a variable-volume piston integrally assembled on the guide such that the volume of the variable-volume piston increases during downward movement and decreases during upward movement, thereby changing the volume of the upper portion of the main piston; and a fluid storage-and-supply unit for supplying fluid to the upper and lower portions of the main cylinder, wherein the volume change of the variable-volume piston allows the main piston to move a greater distance when it is moved, even without reducing the volume thereof, thereby boosting the pressure of the fluid discharged through the lower portion of the main cylinder.

In addition, the pressurization means includes: a first cylinder provided with a fluid upper port and a fluid lower port in the upper and lower portions of a first piston; a first spring installed on the upper portion of the first cylinder so as to be compressed when the first movable shaft of the first piston moves upwards and to lower the first piston with elastic tension; and a second cylinder having a pressurizing piston that is provided on the lower portion of the first movable shaft so as to operate together with the first piston.

In addition, there are further provided a boosting cylinder connected to a lower flow path at the lower portion of the main cylinder such that a boosting piston is operated by the fluid output by the main piston; and a high pressure cylinder having a high pressure piston that operates together with the boosting piston and provided with a high pressure fluid outlet and a fluid supply line in front.

### Effect of the Invention

According to the present invention described as above, when the pressurization means is lowered so as to pressurize the fluid that has been introduced in a certain amount into the upper portion of the main piston of the main cylinder, the volume of the upper portion of the main piston is further reduced due to not only the volume decrease by the lowering of the pressurization means but also the volume change by a variable-volume piston, so that the main piston moves a greater distance when it is moved, even without reducing the volume thereof, thereby boosting the pressure of the fluid discharged through the lower portion of the main cylinder.

In addition, by discharging the high pressure fluid of which pressure is boosted by the volume change of the variable-volume piston, there is an effect that the hydraulic booster using a variable-volume piston can be used in general industrial machines such as hydraulic breakers that require high pressure fluid.

Furthermore, the boosted hydraulic power of the fluid output from the main cylinder is proportional to the number of variable-volume pistons stacked on the guide in the main cylinder, so the number of variable-volume pistons can be controlled according to required hydraulic power, thus facilitating manufacturing.

### BRIEF DESCRIPTION OF THE DRAWINGS

FIG. 1a to FIG. 1d are cross-sectional views showing the structure of a hydraulic booster in operation according to the present invention,

FIG. 2a and FIG. 2b are enlarged views of a variable-volume piston before and after operation according to the present invention,

FIG. 3 is an exploded view of component parts of the variable-volume piston according to the present invention,

FIG. 4 is a plan sectional view of a main piston in a main cylinder according to the present invention,

FIG. 5 is a plan sectional view of a part with a support ring in the main cylinder of the present invention, and

FIG. 6 is a view of a state in which a plurality of variable-volume pistons is installed in the present invention.

### EXPLANATION OF REFERENCE NUMERALS

100: Main cylinder
101: Main piston
102: Central shaft
104: Guide holder
105: Guide rod
106: Second return spring
107: Fluid channel
110: Guide
111: Stopper
112: First return spring
120: First cylinder
121: First piston
122: First movable shaft
123, 125: Fluid upper and lower ports
130: First spring
140: Second cylinder
141: Pressurizing piston
142: Air chamber
150: Boosting cylinder
151: Boosting piston
152: Third return spring
160: High pressure cylinder
161: High pressure piston
162: High pressure fluid outlet
163: Fluid supply line
170: Fluid storage-and-supply unit (RTOP) (including oil pump)
200: Variable-volume piston
210: Piston housing
211: Cap
212: Elongated hole
220: Movable body
221: First section
222: Second section
230: First fixture
240: Second fixture
241: Entry part
242: Ventilation passage
250: Support ring
l: Length
α: Extension part

### MODE FOR CARRYING OUT THE INVENTION

Since the following description of the present disclosure is only for describing embodiments for structural or functional description, the scope of the present invention should not be construed as being limited by the embodiments specified herein.

That is, it should be understood that since the embodiments of the present disclosure may have various changes and may have various forms, equivalents capable of implementing the technical idea fall within the scope of the present invention. In addition, the objects or effects presented in the present invention do not mean that a specific embodiment should include all of them or only such effects, so the scope of the present invention should not be construed as being limited thereto.

Hereinafter, exemplary embodiments capable of effectively achieving the features of the present invention and the effects thereof will be described in detail with reference to the accompanying drawings.

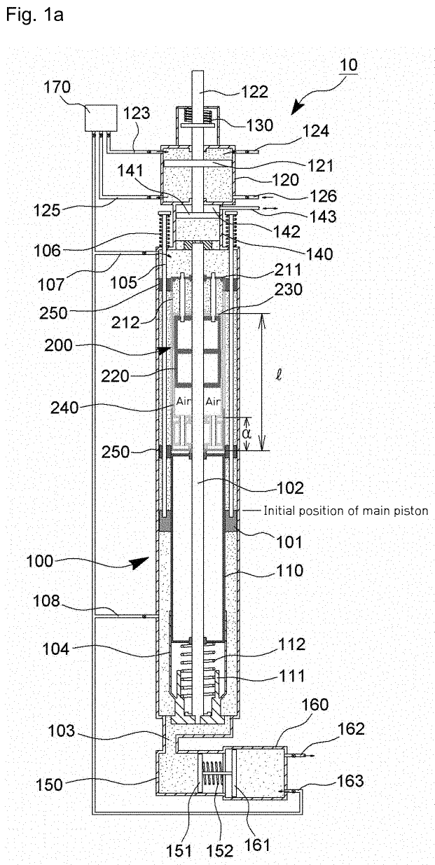

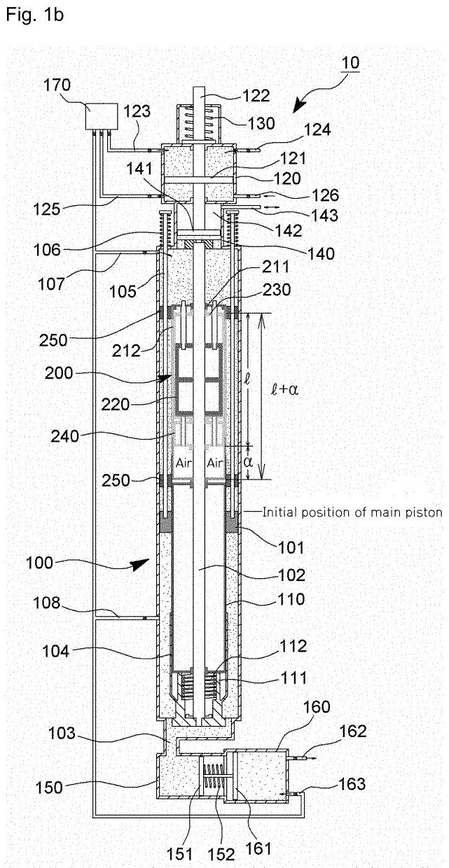

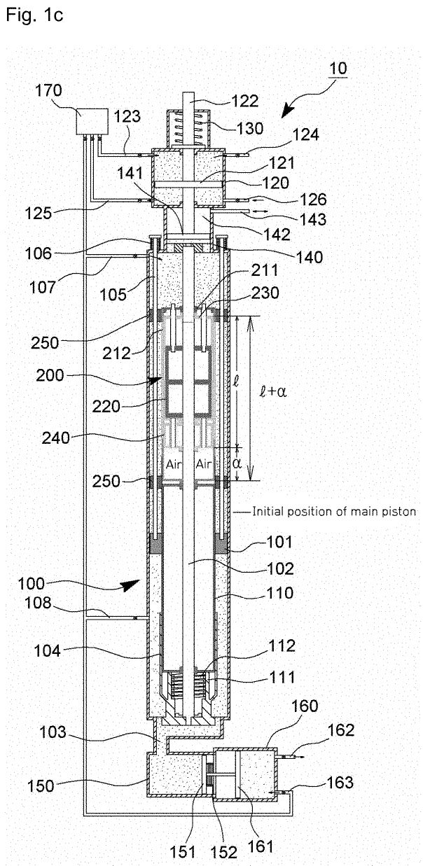

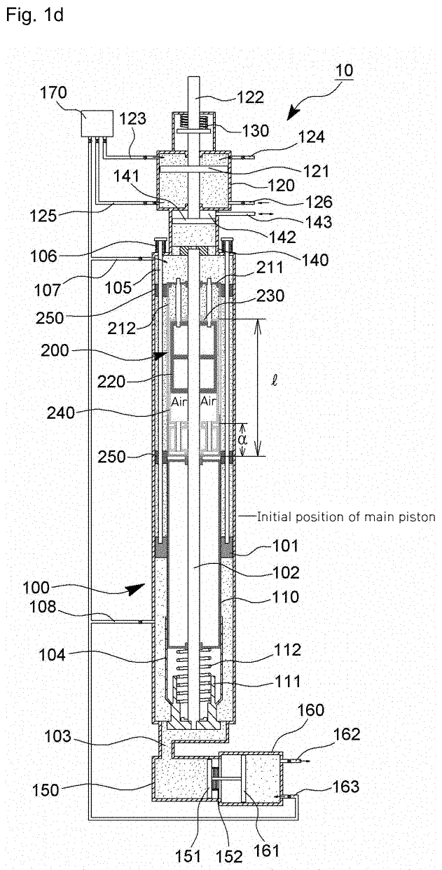

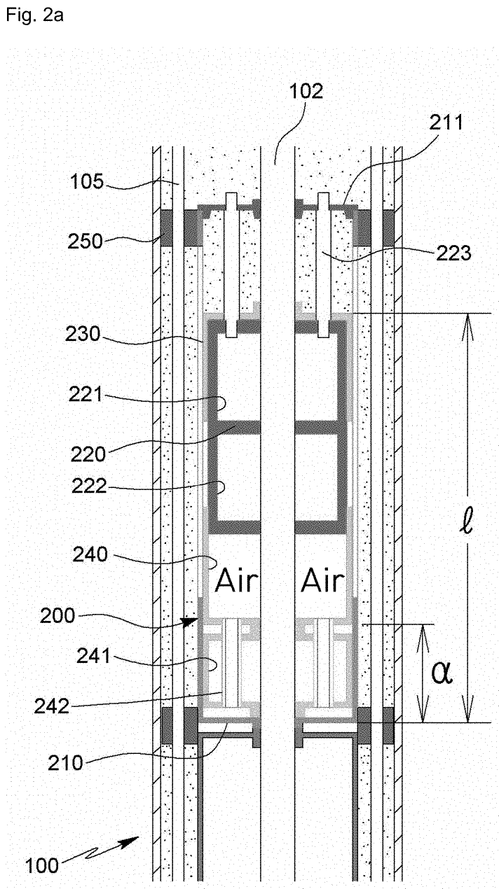

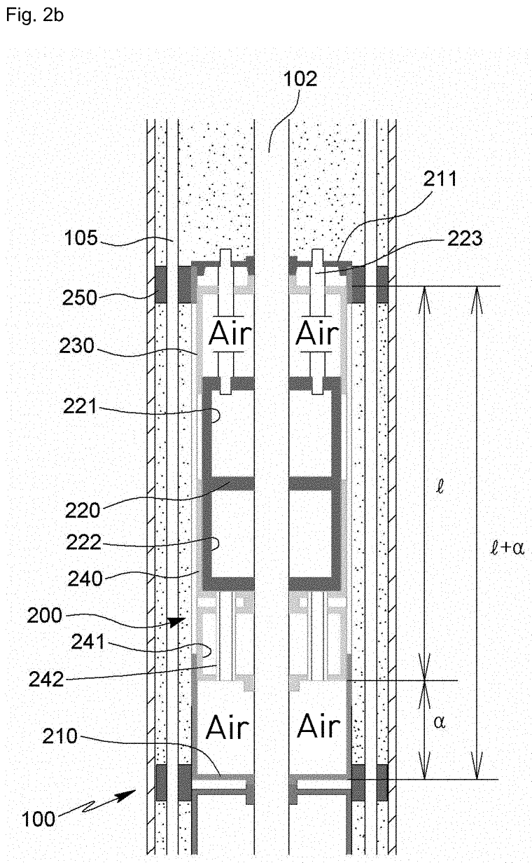

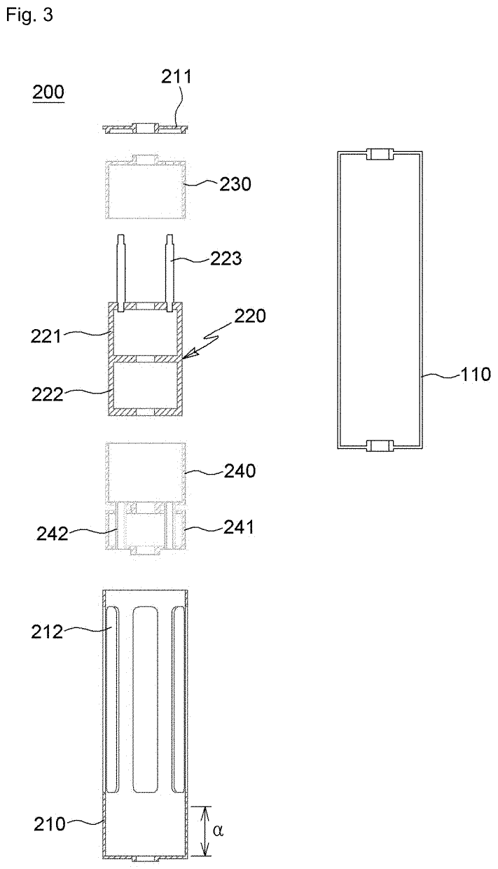

FIG. 1a to FIG. 1d are cross-sectional views showing the structure of a hydraulic booster in operation according to the present invention, FIG. 2a and FIG. 2b are enlarged views of a variable-volume piston before and after operation according to the present invention, and FIG. 3 is an exploded view of a guide and component parts of the variable-volume piston according to the present invention.

Referring to the drawings, a hydraulic booster according to the present invention will be described for each embodiment as follows.

### <First Embodiment> An Embodiment of a Hydraulic Booster

Referring to FIG. 1a, a hydraulic booster according to the present invention includes a main cylinder 100 provided with a ring-shaped main piston 101, a guide 110 for guiding the ring-shaped main piston 101, and a variable-volume piston 200 of which volume changes when the variable-volume piston moves upwards or downwards together with the guide 110 on the main piston 101, in order to increase the pressure of the fluid discharged through the lower portion of the main cylinder 100.

Herein, the main cylinder 100 is provided with a ring-shaped main piston 101 so that the main piston can move, and is configured such that when fluid flowing into the upper portion of the main cylinder 100 through a fluid channel 107 is pressurized by a pressurization means, fluid filled in the lower portion of the main piston 101 through a fluid channel 108 is discharged to the outside through a lower flow path 103.

As the pressurization means, a pressurizing piston 141 operated by the tension of a spring 130 described in a second embodiment below may be used, which will be described in detail in the second embodiment below.

The fluid channels 107, 108 are provided with electromagnetic valves using solenoids, etc. so as to be automatically closed when a set amount of fluid is filled and automatically opened when fluid access is required, under the control of a computer. In addition, the lower flow path 103 is also installed with a solenoid valve so as to be automatically opened and closed according to the entry and exit of fluid.

The guide 110 that is fitted into the main piston 101 is installed with a certain length on the central shaft 102 of the main cylinder 100 so as to guide the movement of the main piston 101, wherein the guide 110 moves downwards separately from the main piston 101 and then moves upwards to an original position by a return means.

The variable-volume piston 200 is integrally assembled on the guide 110 so as to move downwards before the main piston when fluid pressure by the pressurization means is transmitted. Thus, the variable-volume piston 200 integrally assembled on the guide 110 carries out upward/downward movement together with the guide 110, wherein the variable-volume piston 200 is configured such that the volume thereof increases during downward movement and decreases during upward movement, thereby changing the interior volume of the upper portion of the main piston 101.

In addition, the fluid channels 107 and 108 of the main cylinder 100 are connected to a fluid storage-and-supply unit RTOP 170 by a line so as to be supplied with predetermined flow rates, and for this purpose, the fluid storage-and-supply unit RTOP 170 is provided with an oil pump (not shown in the drawings) that supplies flow rates to the fluid channels 107, 108 at a pressure set according to a driving program of a control unit.

According to the present invention, in a state, where the upper and lower portions of the main piston 101 are fully filled with fluid, when fluid in an amount set in the control unit is introduced into the upper portion of the main piston 101 and is pressurized by the pressurization means that is lowered, the volume of the upper portion of the main piston 101 decreases by the lowering of the pressurization means and the force of the pressurized fluid acts first on the variable-volume piston 200 that is near the pressurized fluid, so the variable-volume piston 200 and the guide 110 are first move downwards a certain distance while the main piston 101 remains in place.

The guide 110 is formed with a length greater than the distance of the downward movement, so only the guide 110 is lowered while the ring-shaped main piston 101 is maintained at its initial position in the fitted state.

At this time, a stopper 111 for controlling a downward movement stroke and a first return spring 112 as a return means are provided under the lower portion of the guide 110, so that the guide 110 that moves downwards compresses the first return spring 112 while moving downwards together with the variable-volume piston 200 until the guide 110 is blocked by the stopper 111.

Herein, due to the structure of the variable-volume piston 200 of which volume increases during the downward movement, the volume of the upper portion of the main piston 101 is significantly reduced by the volume reduction caused by the volume expansion of the variable-volume piston 200 in addition to the volume reduction caused by the lowering of the pressurization means.

In this state, if the guide 110 is blocked by the stopper 111 and does not move downwards any more, the pressing force according to the downward movement of the pressurization means (the pressurizing piston) for a remaining stroke entirely acts on the main piston 101 through a plurality of fluid holes 251 provided in a support ring 250. Therefore, the main piston 101 moves downwards and discharges the fluid at the lower portion, as shown in FIG. 1c.

At this time, since the volume of the upper portion of the main piston 101 is reduced by the change of the variable-volume piston 200 in which the volume is expanded, the stroke length of the main piston 101 can be further increased by the reduced volume compared to pushing without changing the volume of the upper portion of the main piston 101.

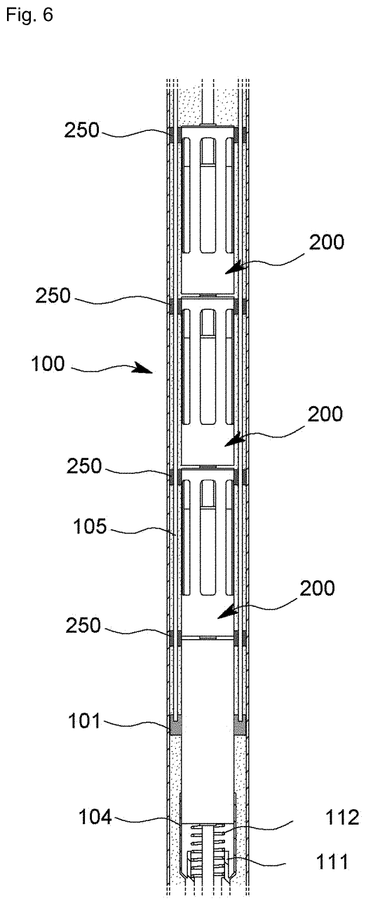

Therefore, it is possible to boost the pressure of the fluid discharged through the lower portion of the main cylinder 100. As described above with reference to FIG. 6 as an example, the boosting the pressure of the fluid discharged increases in proportion to the number of the variable-volume piston 200 to be installed, so a hydraulic booster can be manufactured according to the use thereof.

Hereinafter, the variable-volume piston 200 will be described in detail with respect to the structure and operation process thereof, in which the volume is changed according to the upward/downward movement thereof.

The variable-volume piston 200 includes: a piston housing 210 having an indented extension part a provided at a lower end, an elongated hole 212 provided in the outer circumferential surface of the piston housing 210, through which fluid enters and exits, and a cap 211 provided at an upper end; a movable body 220, which is connected to the cap 211 with a support rod 223 and installed in the center of the piston housing 210 so as to operate integrally with the piston housing 210, and includes a first section 221 and a second section 222; a first fixture 230 attached and fixed to the central shaft 102 at a certain distance from the cap 211 such that an opening part for entry and exit of the first section 221 of the movable body 220 faces the first section 221, wherein air enters and exits according to the degree of entry of the first section 221; and a second fixture 240, which is attached and fixed to the central shaft 102 so that the second section 222 moves in through an opening part and has an entry part 241 provided at the lower end thereof, which moves into and out of the extension part a of the piston housing 210.

This variable-volume piston 200 changes in volume while moving inside the main cylinder 100 that is fully filled with fluid and thus has a structure, in which air enters and exits the inside of the extension part a where the entry part 241 enters and exits and the inside of the first fixture 230 and the second fixture 240 where the first section 221 and the second section 222 of the movable body 220 enter and exit. Only then, the entry and exit of the entry part 241 and the first section 221 and the second section 222 of the movable body 220 can be made smoothly.

As a configuration for this, the central shaft 102 may be formed in a cylindrical shape so as to allow air to enter and exit, and include ventilation holes in areas matching the expansion of the extension part a and the first fixture 230 and the second fixture 240. Then, even if the variable-volume piston 200 operates through the fluid filled in the main cylinder 100, air can smoothly enter and exit through the ventilation holes of the central shaft 102 with respect to the first fixture 230 and the second fixture 240 and the extension part a that extends, enabling smooth operation of the variable-volume piston 200.

Herein, a ventilation passage 242 penetrating the entry part 241 may be provided between the second fixture 240 and the extension part a, so that the air filled inside the second fixture 240 and the extension part a may be moved from the second fixture 240 to the extension part a or from the extension part α to the second fixture 240, depending on the movement direction of the entry part 241, while entry and exit of air with respect to the first fixture 230 is allowed through the ventilation holes of the cylindrical central shaft 102. Therefore, the variable-volume piston 200 can operate smoothly without vacuum.

In addition, even when a guide holder 104 is provided on the inner bottom of the main cylinder 100 so as to smoothly guide the vertical up and down movement of the guide 110, if ventilation holes are provided in an area of the cylindrical central shaft 102 that matches the guide holder 104 so as to allow air inside the guide holder 104 to enter and exit with respect to the central shaft 102, the guide 110 can move smoothly up and down.

As described above, in the present invention, when the fluid on the upper portion of the main cylinder 100 is pressurized by the pressurizing piston 141 by the pressurization means, the fluid pressure exerts first on the near variable-volume piston 200 rather than on the distant main piston 101. Due to this, the variable-volume piston 200 is lowered by a certain stroke length until it is caught by the stopper 111 while compressing the first return spring 112 together with the guide 110 below.

Herein, when the guide 110 is lowered together with the variable-volume piston 200, the main piston 101 is in place while being inserted into the guide 110, and only the guide 110 is lowered. Therefore, it can be said that there is no change in the volume of the upper portion of the main piston 101 due to the lowering of the guide 110.

Meanwhile, the variable-volume piston 200 which is lowered by a certain stroke along the guide 110 as described above has a structure, in which when the variable-volume piston 200 is lowered, the length of the piston housing 210 increases and the volume thereof increases, and when lifted, the length of the piston housing 210 decreases to an original length and the volume thereof decreases.

That is, as shown in FIG. 1a and FIG. 2a, in a state where the variable-volume piston 200 is moved upward along with the guide 110 due to the elastic force of the first return spring 112, the extension part α which adjusts the length of the piston housing 210 by ‘α’ completely enters the entry part 241 of the second fixture 240 and is in a superimposed state.

In addition, the movable body 220 has a structure, in which if the second section 222 exits from the second fixture 240, the first section 221 enters and overlaps the first fixture 230, while if the second section 222 enters and overlaps the second fixture 240, the first section 221 exits from the first fixture 230 in proportion thereto. Therefore, the movement of the movable body 220 does not change the volume.

Therefore, the length l of the piston housing 210 in the state where the variable-volume piston 200 is moved upward is composed of a total of 4 sections of the first fixture 230+the second section 222+the second fixture 240+the entry part 241.

Herein, since the cap 211 assembled into the piston housing 210 is in a state in which the cap 211 is spaced apart from the first fixture 230 and filled with the fluid through the elongated hole 212, the cap 211 is independent of the variable length of the piston housing 210.

In this state, if the pressurizing piston 141 pressurizes the fluid flowing into the upper portion of the main cylinder 100 as above, the pressurizing force first acts on the variable-volume piston 200 supported by the support ring 250, so the variable-volume piston 200 is lowered and compresses the first return spring 112 until the guide 110, which is lowered together with the variable-volume piston 200, is caught by the stopper 111, as shown in FIG. 1b and FIG. 2b.

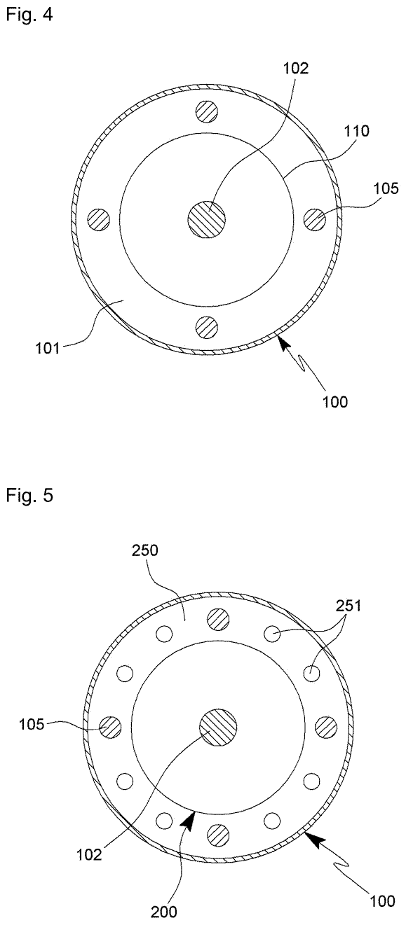

Herein, the support ring 250 is formed in a structure, penetrated by guide rods 105 provided through all sides of the main piston 101 as shown in FIG. 4 and has a plurality of fluid holes 251 provided for the flow of fluid.

At this time, since the cap 211 of the piston housing 210 is as close as possible to the first fixture 230, the fluid inside flows out and fills the upper portion as it is, it is reasonable to assume that there is no volume change due to the movement of the cap 211.

In addition, when the variable-volume piston 200 is lowered, the first fixture 230 and the second fixture 240 are fixed to the central shaft 102, so only the piston housing 210 and the movable body 220 are lowered.

In other words, the second section 222 enters the second fixture 240 while discharging the air of the second fixture 240, in proportion to a distance by which the first section 221 of the movable body 220 exits from the first fixture 230 while allowing the first fixture 230 to be filled with air, wherein the extension part α of the piston housing 210 is lowered out of the entry part 241 of the second fixture 240.

Therefore, as shown in FIG. 1b and FIG. 2b, the length of the piston housing 210 at this time is composed of ‘l+α’ with the ‘extension part α’ in addition to the existing 4 sections of ‘the first fixture 230+the first section 221+the second fixture 240+the entry part 241’.

In this way, the variable-volume piston 200 increases by the length of ‘α’ by the extension part α when moving downwards, so the volume thereof increases. Therefore, the volume of the upper portion of the main piston 101 becomes smaller in proportion to the increased volume of the variable-volume piston 200. This volume change serves to further push the main piston 101 by that much when the fluid acts by the pressing the force of the pressurizing piston 141 on the main piston 101 through the fluid holes 251 of the support ring 250.

That is, if the volume of the upper portion of the main piston 101 becomes decreased as described above, a stroke length that the main piston 101 can be moved by pressurizing a certain amount of fluid can be increased by the volume change, compared to pushing the upper portion of the main piston 101 without the volume change. Accordingly, the pressure of the fluid discharged through the lower flow path 103 of the main cylinder 100 can be boosted, and the boosted fluid can be used elsewhere.

Furthermore, when the downward movement of the main piston 101 is completed, the pressing force becomes weaker than that of the first return spring 112 so that the volume-variable piston 200 applied with the force of the first return spring 112 rises rapidly. Therefore, as shown in FIG. 1d, the length l of the piston housing 210 is reduced to a total of 4 sections of the first fixture 230+the first section 221+the second fixture 240+the entry part 241, so that the volume of the variable-volume piston 200 decreases and the volume of the upper portion of the main piston 101 increases to its original size.

Then, the main piston 101 moves upwards and accordingly the fluid injected into the upper portion is returned to the fluid storage-and-supply unit 170 through the fluid channel 107 and is in a supply ready state for pressurizing the main piston 101 again. Therefore, the above process can be repeated.

The increase in hydraulic power due to the volume change of this variable-volume piston 200 can be increased by increasing the number of variable-volume pistons 200 installed inside the main cylinder 100, as shown in FIG. 6.

In other words, when two variable-volume pistons 200 are installed, the boosting force that increases the pressure of the discharged fluid is increased compared to that when one variable-volume piston 200 is installed, and when three variable-volume pistons 200 are installed, the boosting force that increases the pressure of the discharged fluid is increased compared to that when two variable-volume pistons 200 are installed.

As described above, the present invention can provide a booster capable of boosting the discharge of fluid through the lower flow path 103 of the main cylinder 100, through the change of the variable-volume piston 200, which changes in volume according to the upward and downward movement, when the fluid filled in the upper portion of the main cylinder 100 through the fluid channel 107 of the main cylinder 100 is pressurized by the pressurization means.

### <Second Embodiment> Another Embodiment of a Hydraulic Booster

As the pressurization means provided in the hydraulic booster, a pressurization means using the tension of a spring described below is provided.

The pressurization means using the tension of a spring includes a first cylinder 120, a first spring 130, and a second cylinder 140.

That is, the first cylinder 120 is provided with a fluid upper port 123 and a fluid lower port 125 on the upper and lower portions of the first piston 121 based on the first piston 121, so that the fluid in the fluid storage-and-supply unit 170 alternately flows in and out according to the upward/downward movement of the first piston 121.

The first spring 130 is installed on the upper surface of the first cylinder 120 so as to be compressed when a first movable shaft 122, which is operated together with the first piston 121, moves upwards. The first spring 130 lowers the first piston 121 and the pressurizing piston 141 with elastic tension after reaching a compression peak, thereby pressurizing the fluid.

The second cylinder 140 is provided between the first cylinder 120 and the main cylinder 100, and the pressurizing piston 141 for pressurizing the fluid introduced through the fluid channel 107 is connected to the first piston 121 with the first movable shaft 122 so as to operate together.

With respect to the first cylinder 120, a set flow rate required for driving is frequently supplied or recovered at a set hydraulic pressure through the lines of the fluid storage-and-supply unit 170 connected to the fluid upper port 123 and the fluid lower port 125, wherein the force of the fluid flowing into the fluid lower port 125 has a hydraulic force capable of compressing the first spring 130.

To this end, the fluid storage-and-supply unit 170 is provided with an oil pump (not shown) that pumps a set flow rate at a constant hydraulic pressure according to a driving program of the control unit so as to allow the flow rate to enter and exit the fluid upper port 123 and the fluid lower port 125 of the first cylinder 120.

When pumped high pressure fluid is injected into the fluid lower port 125, the first spring 130 is compressed due to the upward movement of the first piston 121. When the pumped high pressure fluid is injected into the fluid upper port 123, the fluid exits through the fluid lower port 125 and the first piston 121 is quickly lowered by the elastic force of the first spring 130.

In the drawings, unexplained reference numeral 124 denotes an auxiliary fluid outlet provided in the upper portion of the first piston 121, and 126 denotes an auxiliary fluid inlet provided in the lower portion of the first piston 121.

The fluid upper port 123, the fluid lower port 125, the fluid outlet 124 and the fluid inlet 126 are provided with electromagnetic valves using solenoids, etc., and are automatically opened and closed according to the operation process by the setting of the control unit.

When operating the hydraulic booster of the present invention, if fluid of a predetermined hydraulic pressure is supplied to the lower portion of the first piston 121 through the fluid lower port 125 while the fluid inlet 126 is closed, the first piston 121 and the first movable shaft 122 move upward together by the force of the fluid, thereby compressing the first spring 130. At this time, the fluid force that lifts the first piston 121 must have enough force to compress the first spring 130.

In the upward stroke of the first piston 121, the fluid in the upper portion of the first piston 121 is stored in the fluid storage-and-supply unit 170, the air in the air chamber 142 in the upper portion of the pressurizing piston 141 that rises together with the first piston 121 is discharged to the outside, and a set amount of fluid flows into the lower portion through the fluid channel 107, so that the pressurizing piston 141 moves upward smoothly.

After that, the first piston 121 and the pressurizing piston 141 are lowered together by the force of the fluid flowing in through the fluid upper port 123 and the elastic force of the compressed first spring 130.

Herein, the fluid storage-and-supply unit 170 for introducing fluid into and out of the fluid upper port 123 and the fluid lower port 125 and the fluid channels 107, 108 may be separately provided.

When the first piston 121 is lowered, the fluid under the first piston 121 exits through the fluid lower port 125. In addition, the pressurizing piston 141 pressurizes a certain amount of the fluid flowing into the upper portion of the main piston 101 through the fluid channel 107 while smoothly moving downwards as external air flows into the upper air chamber 142.

At this time, the volume of the upper portion of the main piston 101 is decreased to a considerably small size due to the volume decrease due to the lowering of the pressurizing piston 141 as well as the volume change of the variable-volume piston 200, which extends in volume while moving downwards first and compressing the first return spring 112 until being blocked by the stopper 111 as being applied with the pressure of the fluid.

Then, as described with reference to the first embodiment, the main piston 101 moves (downwards) a greater distance than the distance it moves without the volume changes, so that the pressure of the fluid discharged through the lower flow path 103 of the main cylinder 100 can be boosted.

Herein, as for the force for lowering the pressurizing piston 141, the elastic force of the first spring 130 and the force of the fluid flowing into the oil pump provided in the fluid storage-and-supply unit 170 are used.

As described above, the main cylinder 100 having a longer moving distance of the main piston 101 due to the volume reduction of the upper portion can further boost the pressure of the fluid discharged through the lower flow path 103, and the fluid with the boosted pressure can be used as a power source elsewhere.

In addition, when the lowering of the main piston 101 is completed, due to the change of the variable-volume piston 200 of which volume becomes smaller as it rises to the original position by the return means, the volume of the upper portion of the main cylinder 100 increases to its original size. Furthermore, as fluid flows in again through the fluid lower port 125 and the fluid channel 107, the pressurizing piston 141 and the first piston 121 move upwards to their original positions and compress the first spring 130. Therefore, the above process of pressurizing and operating the pressurizing piston 141 can be continuously repeated by the elastic force of the first spring 130 and the force of the fluid flowing into the fluid upper port 123.

### <Third Embodiment> Still Another Embodiment of a Hydraulic Booster

A hydraulic booster further comprises a boosting cylinder 150 and a high pressure cylinder 160 under the main cylinder 100 that forms the fluid engine of the first embodiment.

That is, a continuous operation type hydraulic boosters can be configured, in which the fluid of the main cylinder 100 provided with the pressurization means+the boosting cylinder 150+the high pressure cylinder 160 is introduced or circulated through the fluid storage-and-supply unit 170.

To this end, the boosting cylinder 150 and the high pressure cylinder 160 are provided at the lower portion of the main cylinder 100, wherein the boosting cylinder 150 is connected to the lower flow path 103 of the main cylinder 100 and provided with a boosting piston 151 that operates by the fluid output by the main piston 101.

The high pressure cylinder 160 has a structure in which a high pressure piston 161 operating together with the boosting piston 151 discharges the fluid, which is introduced into the fluid supply line 163, through a high pressure fluid outlet 162, wherein the fluid supply line 163 and the high pressure fluid outlet 162 are provided with electromagnetic valves using solenoids, etc., and are thus automatically opened and closed according to operation.

The fluid storage-and-supply unit 170 further includes a line connected to the fluid supply line 163 of the high pressure cylinder 160, which is opened and closed by the electromagnetic valve so that fluid is supplied to the high pressure cylinder 160. The fluid filled between the main piston 101 and the boosting piston 151 moves between the main piston 101 and the boosting piston 151 according to the direction of the operation.

If the boosting piston 151 of the boosting cylinder 150 moves forwards by a discharge flow rate of the lower flow path 103, the high pressure piston 161 of the high pressure cylinder 160 moves forwards integrally with the boosting piston 151 and thus the fluid filled therein is discharged to the outside through the high pressure fluid outlet 162, so that the discharged high pressure fluid can be used as a power source elsewhere.

After that, the fluid storage-and-supply unit 170 supplies fluid to the high pressure cylinder 160 through the fluid supply line 163 so that the high pressure piston 161 moves backwards, and the high pressure piston 161 and the boosting piston 151 move backwards to their original positions together. Therefore, the internal fluid is sent to the lower portion of the main cylinder 100, so the main piston 101 moves upwards to its original position.

Herein, it is preferable to provide a third return spring 152 for returning the boosting piston 151 in front of the boosting piston 151 in the boosting cylinder 150 so that the third return spring 152 is compressed when the boosting piston 151 moves forwards, wherein when the high pressure piston 161 moves backwards, the boosting piston 151 quickly moves backwards to its original position by the elastic force of the third return spring 152 so that the fluid can be quickly sent to the lower portion of the main cylinder 100.

In addition, the guide rods 105 having a predetermined diameter are provided in all sides of the upper surface of the main piston 101 such that the upper ends of the guide rods 105 protrude to the upper portion of the main cylinder 100, wherein it is preferable that a second return spring 106 is provided on the upper end of each of the guide rods 105 so as to be compressed when the main piston 101 moves downwards.

Then, the main piston 101 moves upwards quickly to its original position by the flow rate returned from the boosting cylinder 150 and the force of the second return spring 106.

In addition, due to the fluid inflow through the fluid lower port 125 of the first cylinder 120 and the fluid discharge through the fluid upper port 123, the first piston 121 moves upwards and the first spring 130 is compressed, thereby forming a ready state.

Therefore, it is possible to provide a hydraulic booster that can boost the pressure of the fluid output through the lower portion of the main cylinder 100 by repeating the above process operated using the tension of the first spring 130 and the pressure of the fluid flowing into the fluid upper port 123, and the hydraulic booster can be very usefully used throughout industrial machinery such as hydraulic breakers.

1. A hydraulic booster using a variable-volume piston, comprising:
a main cylinder configured such that, if fluid introduced into the upper portion of a two-ring type main piston is pressurized by a pressurizing means, fluid in the lower portion of the main piston is output through a lower flow path;
a guide provided on a central shaft so as to guide the movement of the main piston, the guide moving downwards separately from the main piston and then returning to an original position by a return means;
a variable-volume piston integrally assembled on the guide such that the volume of the variable-volume piston increases during downward movement and decreases during upward movement, thereby changing the volume of the upper portion of the main piston;
a fluid storage-and-supply unit connected to fluid channels in the upper and lower portions of the main cylinder so as to supply the fluid to an oil pump,
wherein the variable-volume piston integrally assembled on the guide includes:
a piston housing having an indented extension part (α) provided at a lower end, through which air enters and exits, an elongated hole provided in the outer circumferential surface of the piston housing, through which fluid enters and exits, and a cap provided at an upper end;
a movable body connected to the cap with a support rod and installed in the center of the piston housing so as to operate integrally with the piston housing, and including a first section and a second section;
a first fixture attached and fixed to the central shaft at a certain distance from the cap such that an opening part faces the first section, wherein air enters and exits according to the degree of entry of the first section; and
a second fixture attached and fixed to the central shaft so that the second section moves in through an opening part and having an entry part provided at the lower end, which moves into and out of the extension part (α) of the piston housing, wherein air enters and exits according to the degree of entry of the second section,
wherein pressure of the fluid discharged through the lower portion of the main cylinder can be boosted by a volume change caused by upward/downward movement of the variable-volume piston.

2. The hydraulic booster using a variable-volume piston according to claim 1, wherein the pressurization means includes:
a first cylinder through which fluid in the fluid storage-and-supply unit enters and exits in opposite directions through a fluid upper port and a fluid lower port provided in the upper and lower portions of a first piston;
a first spring installed on the upper portion of the first cylinder so as to be compressed when the first movable shaft of the first piston moves upwards and to lower the first piston with elastic tension; and
a second cylinder having a pressurizing piston that is provided on the lower portion of the first movable shaft so as to operate together with the first piston.

3. The hydraulic booster using a variable-volume piston according to claim 1, wherein the main cylinder includes, at the lower portion thereof:
a boosting cylinder connected to the lower flow path so as to operate with the fluid output from the lower flow path; and
a high pressure cylinder having a high pressure piston that operates together with a boosting piston and provided with a high pressure fluid outlet and a fluid supply line in front.

4. The hydraulic booster using a variable-volume piston according to claim 3, wherein a stopper and a first return spring for controlling a stroke length are provided as return means of the guide at the lower portion of the guide, and the boosting cylinder has a third return spring in front that returns the boosting piston.

5. The hydraulic booster using a variable-volume piston according to claim 1, wherein the main piston is provided with guide rods of a predetermined diameter on the upper surface thereof in four directions such that the upper ends of the guide rods protrude above the main cylinder, and a second return spring that is compressed when the main piston is lowered is provided on each of the upper ends of the guide rods so that the main piston quickly returned to its original position.

6. The hydraulic booster using a variable-volume piston according to claim 1, wherein variable-volume pistons to be installed on the guide are provided in two or more layers according to a required output flow rate, so that a discharge flow rate is further increased by a volume change according to the number of variable-volume pistons.

7. The hydraulic booster using a variable-volume piston according to claim 1, wherein the central shaft is formed in a hollow shape so as to allow air to flow into and out of the inside of the central shaft and has a vent hole in an area where the first fixture is matched so as to allow air to enter and exit through the central shaft depending on whether the first section moves in and out, and a ventilation passage is provided in a penetrating type between the second fixture and the extension part (α) so as to allow internal air to move from the second fixture to the extension part (α) or from the extension part (α) to the second fixture according to the movement direction of the entry part.

8. The hydraulic booster using a variable-volume piston according to claim 1, wherein the central shaft is formed in a cylindrical shape so as to allow air to flow into and out of the inside of the central shaft and has ventilation holes provided in portions matching the first fixture the second fixture and the extension part (α) so that air of the first fixture, the second fixture and the extension part (α) enters and exits through the central shaft.

9. The hydraulic booster using a variable-volume piston according to claim 1, wherein a guide holder is provided on the inner bottom of the main cylinder so as to smoothly guide the upward and downward movement of the guide, and the central shaft is formed in a cylindrical shape so as to allow air to flow into and out of the inside of the central shaft and has a ventilation hole provided in a portion matching the guide holder so that the air in the guide holder enters and exits through the central shaft when the guide is operated.
